(19) United States
(12) Patent Application Publication
(10) Pub. No.: US 2018/0215377 A1
(43) Pub. Date: Aug. 2, 2018

(54) BICYCLE AND MOTORCYCLE PROTECTION BEHAVIORS

(71) Applicant: GM GLOBAL TECHNOLOGY OPERATIONS LLC, Detroit, MI (US)

(72) Inventors: YIQI GAO, MOUNTAIN VIEW, CA (US); ALEXANDER WAINWRIGHT, SAN FRANCISCO, CA (US); BROOKS REED, SAN FRANCISCO, CA (US); ALEXANDER HERTZBERG, BERKELEY, CA (US); JEREMY ALLAN, SAN FRANCISCO, CA (US)

(73) Assignee: GM GLOBAL TECHNOLOGY OPERATIONS LLC, Detroit, MI (US)

(21) Appl. No.: 15/939,543

(22) Filed: Mar. 29, 2018

(51) Int. Cl. B60W 30/09; G05D 1/00; G05D 1/02; B60W 50/14; B60Q 1/50; B60Q 9/00

(52) U.S. Cl. CPC B60W 30/09; G05D 1/0088; B60Q 9/008; B60W 50/14; B60Q 1/50; G05D 1/0223

(57) ABSTRACT

Systems and method are provided for controlling an autonomous vehicle. In one embodiment, a method includes: receiving sensor data from one or more sensors of the vehicle; processing, by a processor, the sensor data to determine a cyclist in proximity to the vehicle; in response to the determined cyclist, selecting, by the processor, a behavioral mode from a plurality of behavioral modes; adjusting, by the processor, at least one control parameter based on the selected behavioral mode; and controlling the autonomous vehicle and/or a notification light based on the at least one control parameter.

The present disclosure generally relates to autonomous vehicles, and more particularly relates to systems and methods for controlling a vehicle when a cyclist is detected in proximity to the vehicle.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While autonomous vehicles and semi-autonomous vehicles offer many potential advantages over traditional vehicles, in certain circumstances it may be desirable for improved operation of the vehicles. For example, in certain instances the autonomous vehicle may encounter a cyclist upon a motorcycle or a bicycle. In such instances, it is desirable for the autonomous vehicle to perform maneuvers such that the bicyclist or motorcyclist can predict the vehicles upcoming behavior and such that the bicyclist or motorcyclist does not feel threatened.

Accordingly, it is desirable to provide systems and methods that detect the presence of the cyclist and that manage operation of the vehicle based on the detection. It is further desirable to manage the operation of the vehicle to protect the cyclist. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling an autonomous vehicle. In one embodiment, a method includes: receiving sensor data from one or more sensors of the vehicle; processing, by a processor, the sensor data to determine a cyclist in proximity to the vehicle; in response to the determined cyclist, selecting, by the processor, a behavioral mode from a plurality of behavioral modes; adjusting, by the processor, at least one control parameter based on the selected behavioral mode; and controlling the autonomous vehicle based on the at least one control parameter.

In various embodiments, the method further includes generating notification signals to illuminate a notification light to notify the cyclist that they have been detected. In various embodiments, the notification light is located in a rear windshield of the vehicle and when illuminated projects light towards the cyclist.

In various embodiments, the method further includes generating notification signals to illuminate a notification light to notify an occupant of the autonomous vehicle that the cyclist has been detected. In various embodiments, the notification light is located on an interior door of the vehicle and when illuminated projects light towards the occupant to warn the occupant not to open the door.

In various embodiments, the behavioral mode is a lateral protection mode, a longitudinal protection mode, a turn protection mode, or a lead car protection mode.

In various embodiments, the at least one control parameter includes vehicle speed and vehicle acceleration or a road corridor.

In another embodiment, a system for controlling an autonomous vehicle is provided. The system includes a non-transitory computer readable medium. The non-transitory computer readable medium includes a first module configured to, by a processor, receive sensor data from one or more sensors of the vehicle, and process the sensor data to determine a cyclist in proximity to the vehicle; a second module configured to, by a processor, in response to the determined cyclist, select a behavioral mode from a plurality of behavioral modes; and a third module configured to, by a processor, adjust at least one control parameter based on the selected behavioral mode, and control the autonomous vehicle based on the at least one control parameter.

In various embodiments, the system further includes a fourth module that, by a processor, generates notification signals to illuminate a notification light to notify the cyclist that they have been detected. In various embodiments, the system further includes a notification light located in a rear windshield of the vehicle and configured to project light towards the cyclist.

In various embodiments, the system further includes a fourth module that, by a processor, generates notification signals to illuminate a notification light to notify an occupant of the autonomous vehicle that the cyclist has been detected. In various embodiments, the system further includes a notification light located on an interior of a door of the vehicle and configured to project light towards the occupant to warn the occupant not to open the door.

In various embodiments, the behavioral mode is at least one of a lateral protection mode, a longitudinal protection mode, a turn protection mode, and a lead car protection mode. In various embodiments, the at least one control parameter includes vehicle speed and vehicle acceleration. In various embodiments, the at least one control parameter includes a road corridor.

In still another embodiment, an autonomous vehicle is provided. The autonomous vehicle includes a plurality of sensors disposed about the vehicle and configured to sense an exterior environment of the vehicle and to generate sensor signals; a control module configured to, by a processor, process the sensor signals to determine a cyclist in proximity to the vehicle, and in response to the determined cyclist, select a behavioral mode from a plurality of behavioral modes, adjust at least one control parameter based on the selected behavioral mode, control the autonomous vehicle based on the at least one control parameter, and generate one or more notification signals; and a notification light configured to receive the one or more notification signals and to illuminate the light to at least one of notify the cyclist that the vehicle is aware of them and notify an occupant of the vehicle to not open the door.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a path planning system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the behavior planning system of the autonomous vehicle, in accordance with various embodiments;

FIGS. 5, 6, 7, and 8 are illustrations of protection zones, in accordance with various embodiments; and

FIG. 9 is a flowchart illustrating a control method for controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

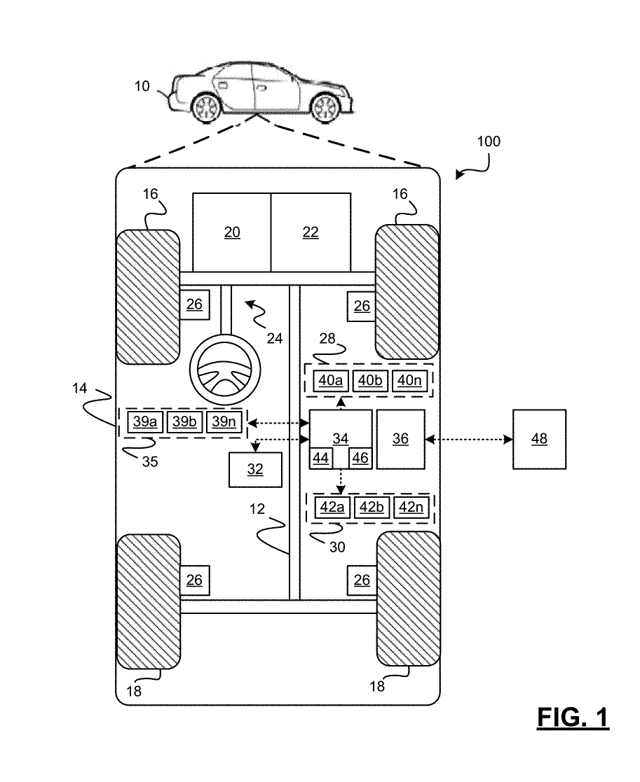

With reference to FIG. 1, a behavior planning system shown generally at 100 is associated with a vehicle 10 in accordance with various embodiments. In general, the behavior planning system 100 receives and processes sensor data and/or map data to determine whether a cyclist situated on a bicycle or motorcycle is in proximity to the vehicle 10. When a cyclist is identified in proximity to the vehicle 10, the behavior planning system 100 selects a behavioral mode from various modes associated with cyclists and controls operation of the vehicle 10 based on the selected behavioral mode. In various embodiments, the various behavioral modes can include, but are not limited to, a lateral protection mode, a longitudinal protection mode, a turn protection mode, and a lead car protection mode. As will be discussed in more detail below, each of the modes includes rules for operating the vehicle 10 such that the cyclist is protected.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the behavior planning system 100 described herein is incorporated into the autonomous vehicle (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, a notification system 25, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

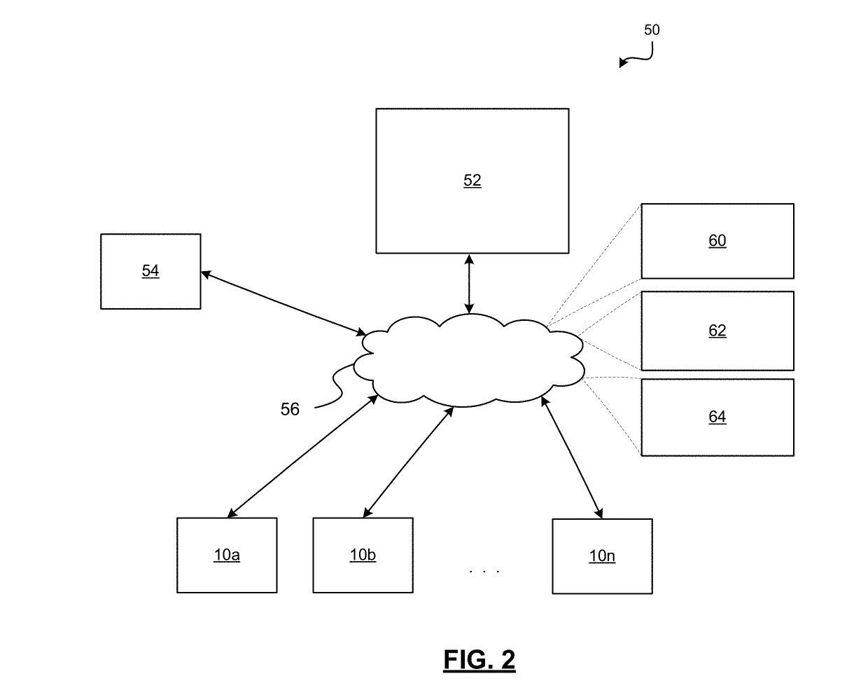

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The notification system 35 includes one or more notification devices, such as, but not limited to, lights 39a-39n having a shade that outlines a cycle or message. The lights 39a-39n can be located at positions on the vehicle 10 such that a cyclist near the vehicle 10 can view the lights 39a-39n and/or located at positions on the vehicle 10 such that an occupant of the vehicle 10 can view the lights 39a-39n. For example, at least one of the lights 39a-39n can be located in a rear windshield of the vehicle and can project light outwards towards cyclists to warn the cyclist that the vehicle is aware of them. In another example, at least one of the lights 39a-39n can be located on an interior door of the vehicle and can project light towards an occupant to warn the occupant not to open the door.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10. In various embodiments, the controller 34 is configured to implement the behavior planning systems and methods as discussed in detail below.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the behavior planning system 100 and, when executed by the processor 44, process sensor data and/or map data, detect cyclists in proximity to the vehicle 10, select a behavioral mode, control operation of the vehicle 10 based on the selected behavioral mode, and generate notification signals to the notification system 35 for notifying the cyclists and/or occupants of the vehicle 10.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

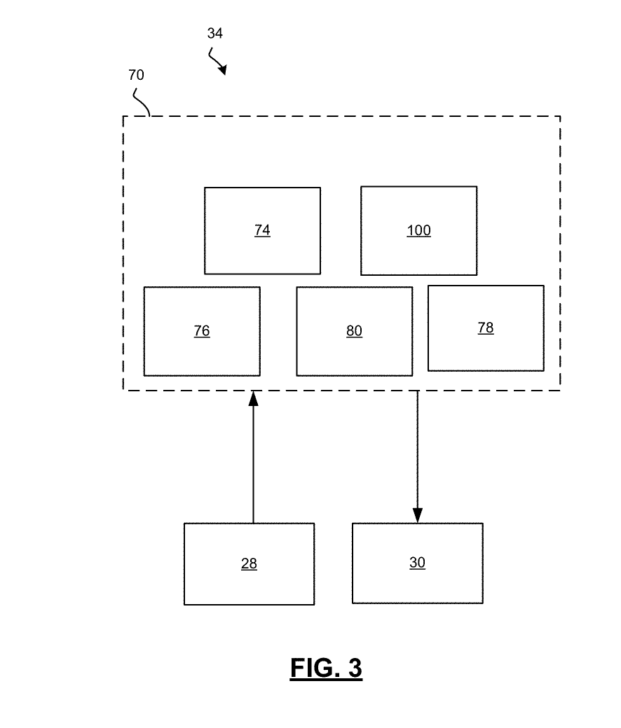

In accordance with various embodiments, the controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the behavior planning system 100 of FIG. 1 is included within the ADS 70, for example, as part of any one of or a combination of the computer vision system 74, the positioning system 76, the guidance system 78, and the vehicle control system 80, or as a separate system. For example, in various embodiments the behavior planning system 100 receives information from the computer vision system 74, and the positioning system 76, and determines whether a cyclist is in proximity of the vehicle and selects a behavioral mode based on a detected cyclist.

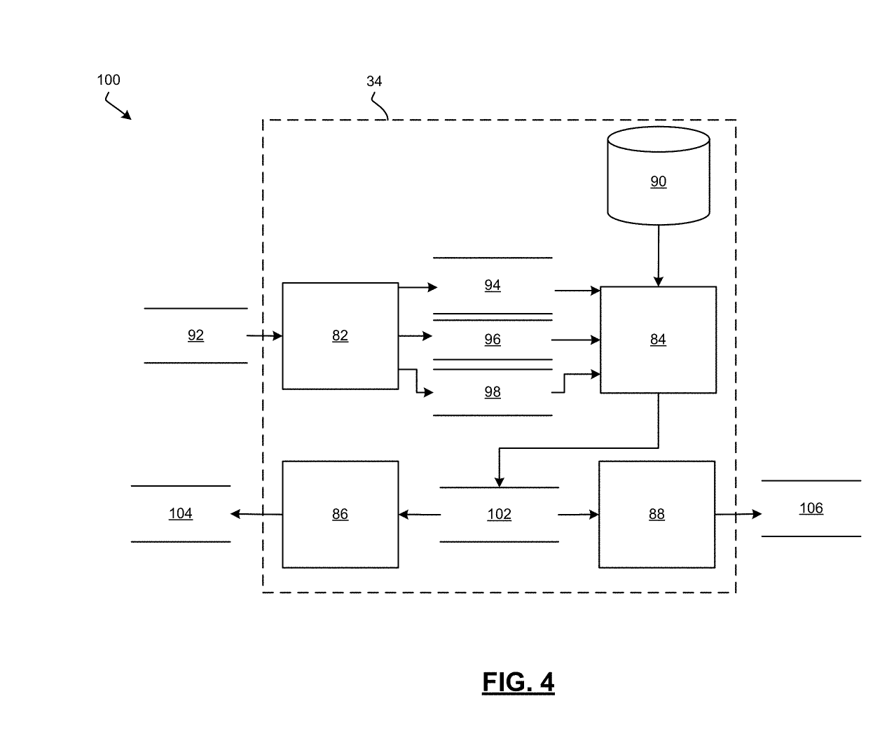

For example, as shown in more detail with regard to FIG. 4 and with continued reference to FIGS. 1-3, the behavior planning system 100 includes a cyclist detection module 82, a mode selection module 84, a vehicle control module 86, a notification module 88, and a mode datastore 90.

The cyclist detection module 82 receives sensor data 92 from the sensing devices 40a-40n such as image sensors, lidar, radar, etc. and processes the sensor data 92 to detect and classify objects in the environment of the vehicle 10. The detection can be by way of any classification method and is not limited to any example. The cyclist detection module 82 then determines if any of the objects are classified as a cycle being operated by a cyclist. The cyclist detection module 82 sets a cyclist detection flag 94 based on whether the detected cycle is being operated by a cyclist. For example, when the detected cycle is being operated by a cyclist, the cyclist detection module 82 sets the cyclist detection flag to TRUE. In another example, when the detected cycle is not being operated by a cyclist (parked or stationary), the cyclist detection module 82 sets the cyclist detection flag to FALSE.

When the cyclist detection flag is FALSE, the cyclist detection module 82 sets a cyclist position 96 and a cyclist trajectory 98 to zero or a null value. When the cyclist detection flag 94 is set to TRUE, the cyclist detection module 82 then determines a position 96 of the detected cycle/cyclist relative to the vehicle 10, and determines a predicted movement/trajectory 98 of the cycle/cyclist. The cyclist detection module 82 determines a predicted movement/trajectory 98 of the cycle/cyclist according to various methods and is not limited to any one example.

The mode selection module 84 receives as input the cyclist detection flag 94, the relative position 96 of the cyclist, and the predicted movement/trajectory 98 of the cyclist. The mode selection module 84 evaluates the cyclist detection flag 94, the relative position 96 of the cyclist, and the predicted movement/trajectory 98 of the cyclist and based on the evaluation selects a mode 102 from a plurality of predefined behavioral modes that are stored in the mode datastore 90. In various embodiments, the plurality of behavioral modes include, but are not limited to, a default mode, a lateral protection mode, a longitudinal protection mode, a turn protection mode, a lead car protection mode. The modes each include rules for adjusting parameters associated with controlling the vehicle 10.

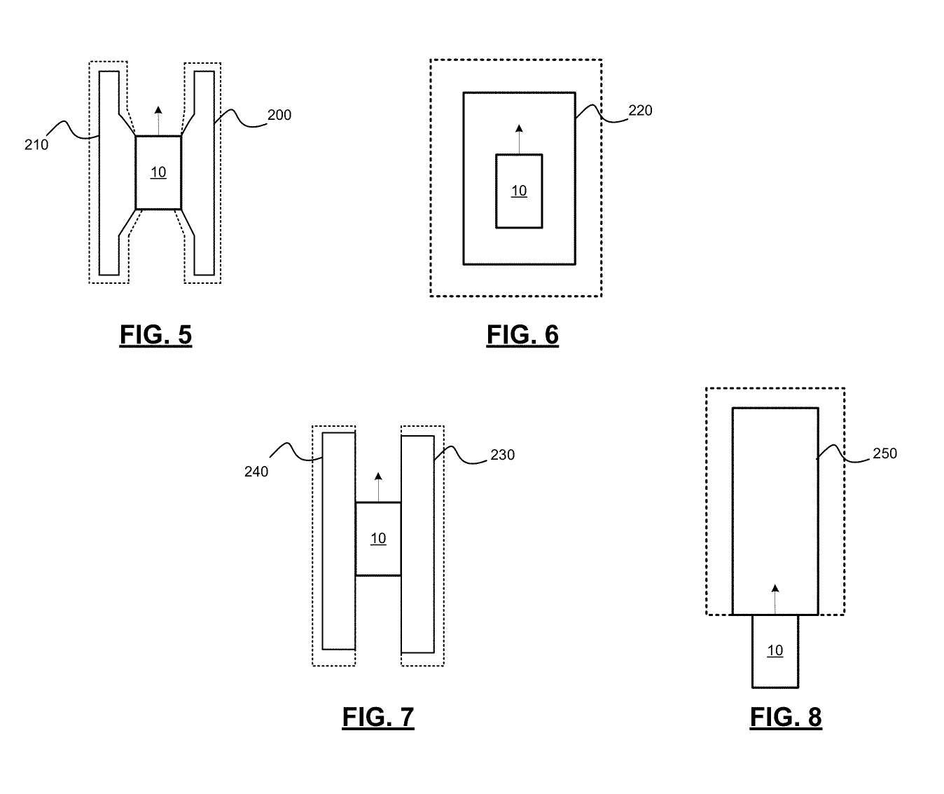

In various embodiments, the mode selection module 84 selects the mode 102 to be the default mode when the cyclist detection flag 94 indicates FALSE. In various other embodiments, the mode selection module 84 selects the mode 102 to be the longitudinal protection mode when the cyclist detection flag 94 indicates TRUE, and the relative position 96 of the cyclist and the predicted movement/trajectory 98 of the cyclist indicate that the cyclist is traveling to the left or to the right of the vehicle 10. For example, as shown in more detail in FIG. 5, the mode selection module 84 selects the mode 102 to be the longitudinal protection mode when the relative position 96 of the cyclist and the predicted movement/trajectory 98 of the cyclist fall within one of longitudinal zones 200, 210.

In various embodiments, the mode selection module 84 selects the mode 102 to be the lateral protection mode when the cyclist detection flag 94 indicates TRUE, and the relative position 96 of the cyclist and the predicted movement/trajectory 98 of the cyclist indicate that the cyclist is traveling within a close vicinity of the vehicle 10. For example, as shown in more detail in FIG. 6, the mode selection module 84 selects the mode 102 to be the lateral protection mode when the relative position 96 of the cyclist and the predicted movement/trajectory 98 of the cyclist fall within a lateral zone 220.

In various embodiments, the mode selection module 84 selects the mode 102 to be the turn protection mode when the cyclist detection flag 94 indicates TRUE, and the relative position 96 of the cyclist and the predicted movement/trajectory 98 of the cyclist indicate that the cyclist is traveling on a right side or a left side of the vehicle 10 and in a same direction of the vehicle 10. For example, as shown in more detail in FIG. 7, the mode selection module 84 selects the mode 102 to be the turn protection mode when the relative position 96 of the cyclist and the predicted movement/trajectory 98 of the cyclist fall within one of turn zones 230, 240.

In various embodiments, the mode selection module 84 selects the mode 102 to be the lead car protection mode when the cyclist detection flag 94 indicates TRUE, and the relative position 96 of the cyclist and the predicted movement/trajectory 98 of the cyclist indicate that the cyclist is traveling in front of the vehicle 10. For example, as shown in more detail in FIG. 8, the mode selection module 84 selects the mode 102 to be the lead car protection mode when the relative position 96 of the cyclist and the predicted movement/trajectory 98 of the cyclist fall within a lead zone 250.

As can be appreciated, more than one mode of the various modes can be selected at any one time.

The vehicle control module 86 receives as input the selected mode 102. The vehicle control module 86 controls the operation of the vehicle 10 based on the selected mode 102. In various embodiments, each of the modes are defined by rules for controlling the vehicle 10 when in the mode, and the vehicle control module 86 controls the vehicle 10 by adjusting control parameters 104 based on the rules of the selected mode 102. The vehicle control system 80 (FIG. 3) then receives the control parameters 104 and adjusts the control of the vehicle 10.

For example, when the selected mode 102 is the longitudinal protection mode, speed parameters, acceleration parameters, and/or road corridor parameters (defining the space in which the vehicle 10 is planning to travel) are adjusted such that the vehicle 10 is controlled to stay behind the cyclist if the cyclist is in front of the vehicle 10. In another example, when the selected mode 102 is the longitudinal protection mode, the speed parameters, acceleration parameters, and/or road corridor parameters are adjusted such that the vehicle 10 is controlled to maneuver around the cyclist if the cyclist is travelling at a speed less than a defined speed or the vehicle's speed.

In another example, when the selected mode 102 is the lateral protection mode, a road corridor parameter is adjusted such that the vehicle 10 is controlled to travel in a corridor that is laterally offset from a default corridor for a distance expected to maneuver around or travel beside the cyclist.

In still another example, when the selected mode is the turn protection mode, the speed parameters, acceleration parameters, and/or road corridor parameters (defining the space in which the vehicle 10 is planning to travel) are adjusted such that the vehicle 10 is controlled to wait for the cyclist to go before making the turn. In still another example, when the selected mode is the turn protection mode, the speed parameters, acceleration parameters, and/or road corridor parameters (defining the space in which the vehicle 10 is planning to travel) are adjusted such that the vehicle 10 is controlled to turn before the cyclist.

In still another example, when the selected mode 102 is the lead car protection mode, the cyclist will be treated as a lead car, which means the vehicle will stay behind the cyclist while staying inside the lane and not try passing it.

The notification module 88 receives as input the selected mode 102, the cyclist position 96, and/or the predicted movement/trajectory 98 of the cyclist. The notification module 88 selectively illuminates one or more of the notification lights 39a-39n (FIG. 1) based on the selected mode 102, the cyclist position 96, and/or the predicted movement/trajectory 98 of the cyclist. For example, when the cyclist is approaching a rear right side of the vehicle 10 and the selected mode 102 is the lateral protection mode, a notification signal 106 is generated to illuminate a notification light (e.g., a light that illuminates an image of a cycle, a message, or other notification) located in the rear right side of the vehicle 10 such that the cyclist can view the notification. The notification serves as a mechanism to communicate to the cyclist that the vehicle 10 has recognized the cyclist. The cyclist can then better predict the operation of the vehicle 10. As can be appreciated, in various embodiments notification signals 106 can be selectively generated to any notification light or lights 39a-39n located about the vehicle 10 to notify occupants of the vehicle 10 and/or the cyclist traveling near the vehicle 10 that the vehicle 10 recognizes the cyclist.

It will be understood that various embodiments of the behavior planning system 100 according to the present disclosure may include any number of additional sub-modules embedded within the controller 34 which may be combined and/or further partitioned to similarly implement systems and methods described herein. Furthermore, inputs to the behavior planning system 100 may be received from the sensor system 28, received from other control modules (not shown) associated with the autonomous vehicle 10, received from the communication system 36, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

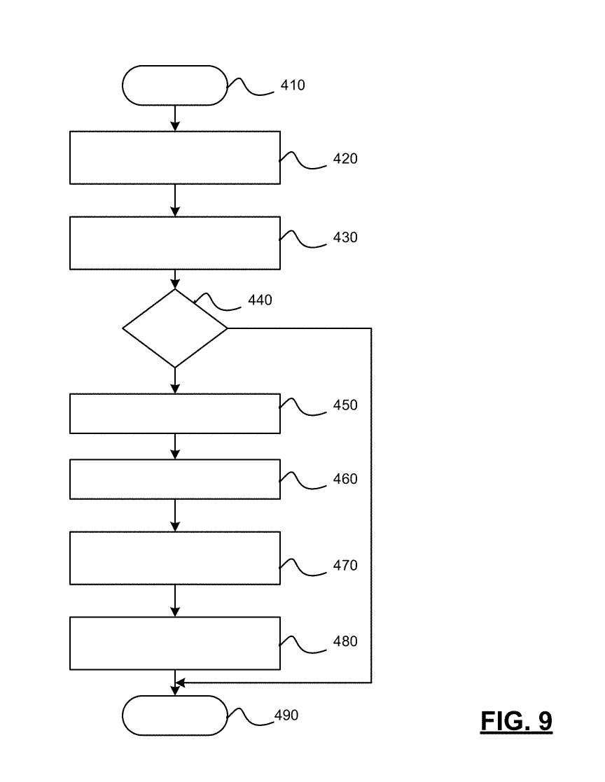

Referring now to FIG. 9, and with continued reference to FIGS. 1-4, a flowchart illustrates a control method 400 that can be performed by the behavior planning system 100 of FIG. 4 in accordance with the present disclosure. As can be appreciated in light of the disclosure, the order of operation within the method is not limited to the sequential execution as illustrated in FIG. 9, but may be performed in one or more varying orders as applicable and in accordance with the present disclosure. In various embodiments, the method 400 can be scheduled to run based on one or more predetermined events, and/or can run continuously during operation of the autonomous vehicle 10.

In various embodiments, the method may begin at 410. The sensor data 92 is received at 420. The sensor data 92 is processed to determine if a cyclist is in proximity to the vehicle 10 at 430. When the cyclist is detected at 440, the relative position 96 of the cyclist, and the predicted movement/trajectory 98 of the cyclist are determined at 450. Further when the cyclist is detected at 440, the mode 102 is selected at 460 from the lateral protection mode, the longitudinal protection mode, the turn protection mode, and the lead car protection mode, for example, as discussed above.

Based on the selected mode 102, the notification signals 106 are generated at 470, for example, as discussed above, and the control parameters 104 are generated at 480, for example, as discussed above. Thereafter, the method may end at 490.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling an autonomous vehicle, comprising:
receiving sensor data from one or more sensors of the vehicle;
processing, by a processor, the sensor data to determine a cyclist in proximity to the vehicle;
in response to the determined cyclist, selecting, by the processor, a behavioral mode from a plurality of behavioral modes;
adjusting, by the processor, at least one control parameter based on the selected behavioral mode; and
controlling the autonomous vehicle based on the at least one control parameter.

2. The method of claim 1, further comprising generating notification signals to illuminate a notification light to notify the cyclist that they have been detected.

3. The method of claim 2, wherein the notification light is located in a rear windshield of the vehicle and when illuminated projects light towards the cyclist.

4. The method of claim 1, further comprising generating notification signals to illuminate a notification light to notify an occupant of the autonomous vehicle that the cyclist has been detected.

5. The method of claim 4, wherein the notification light is located on an interior door of the vehicle and when illuminated projects light towards the occupant to warn the occupant not to open the door.

6. The method of claim 1, wherein the behavioral mode is a lateral protection mode.

7. The method of claim 1, wherein the behavioral mode is a longitudinal protection mode.

8. The method of claim 1, wherein the behavioral mode is a turn protection mode.

9. The method of claim 1, wherein the behavioral mode is a lead car protection mode.

10. The method of claim 1, wherein the at least one control parameter includes vehicle speed and vehicle acceleration.

11. The method of claim 1, wherein the at least one control parameter includes a road corridor.

12. A system for controlling an autonomous vehicle, comprising:
a non-transitory computer readable medium comprising:
a first module configured to, by a processor, receive sensor data from one or more sensors of the vehicle, and process the sensor data to determine a cyclist in proximity to the vehicle;
a second module configured to, by a processor, in response to the determined cyclist, select a behavioral mode from a plurality of behavioral modes; and
a third module configured to, by a processor, adjust at least one control parameter based on the selected behavioral mode, and control the autonomous vehicle based on the at least one control parameter.

13. The system of claim 12, further comprising a fourth module that, by a processor, generates notification signals to illuminate a notification light to notify the cyclist that they have been detected.

14. The system of claim 13, further comprising the notification light located in a rear windshield of the vehicle and configured to project light towards the cyclist.

15. The system of claim 12, further comprising a fourth module that, by a processor, generates notification signals to illuminate a notification light to notify an occupant of the autonomous vehicle that the cyclist has been detected.

16. The system of claim 15, further comprising the notification light located on an interior of a door of the vehicle and configured to project light towards the occupant to warn the occupant not to open the door.

17. The system of claim 12, wherein the behavioral mode is at least one of a lateral protection mode, a longitudinal protection mode, a turn protection mode, and a lead car protection mode.

18. The system of claim 12, wherein the at least one control parameter includes vehicle speed and vehicle acceleration.

19. The system of claim 12, wherein the at least one control parameter includes a road corridor.

20. An autonomous vehicle, comprising:
A plurality of sensors disposed about the vehicle and configured to sense an exterior environment of the vehicle and to generate sensor signals;
a control module configured to, by a processor, process the sensor signals to determine a cyclist in proximity to the vehicle, and in response to the determined cyclist, select a behavioral mode from a plurality of behavioral modes, adjust at least one control parameter based on the selected behavioral mode, control the autonomous vehicle based on the at least one control parameter, and generate one or more notification signals; and
a notification light configured to receive the one or more notification signals and to illuminate the light to at least one of notify the cyclist that the vehicle is aware of them and notify an occupant of the vehicle to not open the door.
